(19) United States
(12) Patent Application Publication
(10) Pub. No.: US 2024/0326933 A1
(43) Pub. Date: Oct. 3, 2024

(54) COUPLER ASSEMBLY

(71) Applicant: STI Holdings, Inc., Stoughton, WI (US)

(72) Inventors: Denys Bykovskyi, Madison, WI (US); Matthew Simon Kinsman, Fort Atkinson, WI (US)

(21) Appl. No.: 18/622,255

(22) Filed: Mar. 29, 2024

Related U.S. Application Data
(60) Provisional application No. 63/492,951, filed on Mar. 29, 2023.

(51) Int. Cl. B62D 53/08

(52) U.S. Cl. CPC B62D 53/0842

(57) ABSTRACT

A coupler assembly for a trailer includes a base plate, a king pin assembly coupled to the base plate, the king pin assembly configured to be coupled to a fifth wheel of a tractor, and a support frame coupled to the base plate and configured to brace the king pin assembly. The support frame includes a pair of outboard reinforcement members forming an obtuse included angle therebetween, and a pair of inboard reinforcement members forming an acute included angle therebetween. The pair of inboard reinforcement members are disposed within the obtuse angle formed by the pair of outboard reinforcement members. The obtuse angle formed by the pair of outboard reinforcement members and the acute angle formed by the pair of inboard reinforcement members are each bisected by a longitudinal axis of the trailer.

### CROSS-REFERENCE TO RELATED APPLICATIONS

This application claims priority to U.S. Provisional Patent Application No. 63/492,951, filed on Mar. 29, 2023, the entire contents of which are incorporated herein by reference.

### BACKGROUND

The invention relates to over-the-road trailers and in particular, to the king pin coupler assembly of the over-the-road trailer for establishing a connection with a truck or tractor, such couplings are known as fifth wheel couplings.

### SUMMARY

In one aspect, a coupler assembly for a trailer includes a base plate, a king pin assembly coupled to the base plate, the king pin assembly configured to be coupled to a fifth wheel of a tractor, and a support frame coupled to the base plate and configured to brace the king pin assembly. The support frame includes a pair of outboard reinforcement members forming an obtuse included angle therebetween, and a pair of inboard reinforcement members forming an acute included angle therebetween. The pair of inboard reinforcement members are disposed within the obtuse included angle formed by the pair of outboard reinforcement members. The obtuse included angle formed by the pair of outboard reinforcement members and the acute included angle formed by the pair of inboard reinforcement members are each bisected by a longitudinal axis of the coupler assembly.

In another aspect, a coupler assembly for a trailer includes a lower wall, an upper wall disposed opposite the lower wall, a first lateral wall extending in a longitudinal direction of the trailer, the first lateral wall coupled to the lower wall and to the upper wall, and a second lateral wall opposite the first lateral wall, the second lateral wall coupled to the lower wall and to the upper wall. A front wall is positioned at a forward end of the trailer. The front wall is coupled to the lower wall and to the upper wall. A king pin assembly is disposed in an area defined within the first lateral wall, the second lateral wall, and the front wall and extending downwardly beyond the lower wall. A plurality of forward reinforcement members are disposed between the king pin assembly and the front wall. The coupler assembly includes a plurality of rearward reinforcement members. The plurality of forward reinforcement members are disposed at oblique angles relative to the front wall, the first lateral wall, and the second lateral wall.

In yet another aspect, a cargo trailer includes a cargo area defined between a front end and a rear end, the rear end having an opening configured for loading and unloading cargo, and a coupler assembly provided at a bottom portion of the front end. The coupler assembly includes a plurality of rearward reinforcement members, a downwardly protruding kingpin disposed within the plurality of rearward reinforcement members, and a plurality of forward reinforcement members. Each of the plurality of forward reinforcement members having a L-shaped cross-section taken perpendicular to a longitudinal axis of the reinforcement member.

### BRIEF DESCRIPTION OF THE DRAWINGS

FIG. 1 is side view of a trailer according to an embodiment of the present disclosure.

FIG. 2 is an upper perspective view of a coupler assembly.

FIG. 3 is a lower perspective view of the coupler assembly of FIG. 2

FIG. 4 is a lower perspective view of the coupler assembly of FIG. 2, with a base plate hidden for clarity.

FIG. 5 is a bottom view of the coupler assembly of FIG. 4.

FIG. 6 is a perspective view of a rearward reinforcement member.

FIG. 7 is a perspective view of an outboard reinforcement member.

FIG. 8 is a perspective view of an inboard reinforcement member.

FIG. 9 is a perspective view of a rearward gusset.

FIG. 10 is a perspective view of a forward gusset.

### DETAILED DESCRIPTION

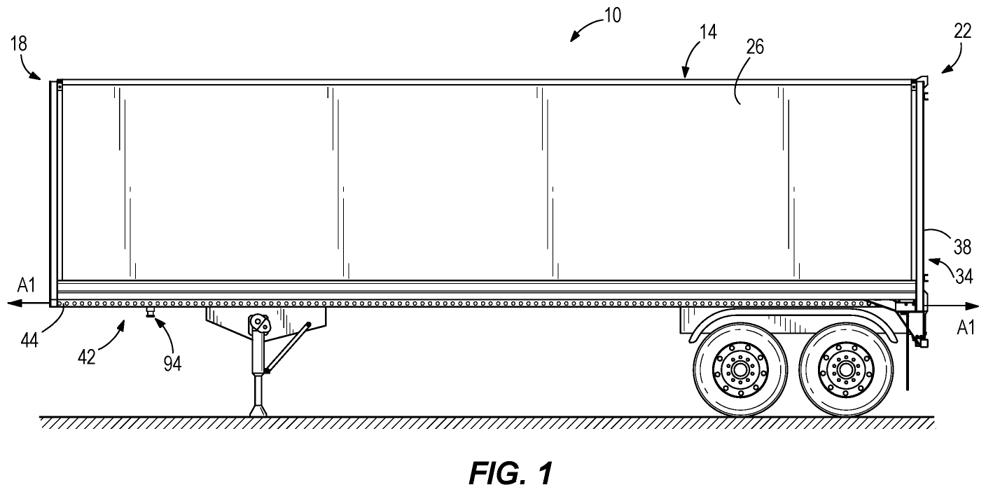

FIG. 1 illustrates a cargo trailer 10, such as an enclosed over-the-road commercial transport semi-trailer or “dry van,” although the trailer may take a variety of other configurations. The trailer 10 includes a cargo area 14 defined between a front or leading end 18 and a rear or trailing end 22. A longitudinal axis Al of the trailer 10 extends between the front end 18 and the rear end 22 and is positioned centrally within the trailer 10 (e.g., forms a centerline of the trailer 10) to define a longitudinal direction of the trailer 10. The cargo area 14 includes a plurality of walls 26 extending in the longitudinal direction of the trailer 10 that define an interior space which contains cargo when the trailer 10 is in use. An opening 34 is positioned at the rear end 22 to allow for loading and unloading of cargo, and a door 38 is coupled to the opening 34 to selectively close the opening 34. A coupler assembly 42 is disposed at a bottom portion 44 of the front end 18 of the trailer 10 and allows a tractor or other truck (not shown) to selectively attach to the trailer 10. The coupler assembly 42 is centered in the trailer 10 such that the longitudinal axis Al is also a central longitudinal axis of the coupler assembly 42. As will be described in greater detail herein, the coupler assembly 42 of the illustrated embodiment has a decreased weight when compared to prior coupler assemblies, while maintaining the necessary strength to transmit loads from the tractor to the trailer 10. Over-the-road commercial transport trailers 10 are subject to limitations of the combined weight of the trailer 10 and the load within the trailer 10. By decreasing the weight of the coupler assembly 42, and thus the trailer 10, the overall load capacity of the trailer 10 is increased. On the other hand, whenever additional load capacity is not utilized, the reduced weight results in increased fuel economy.

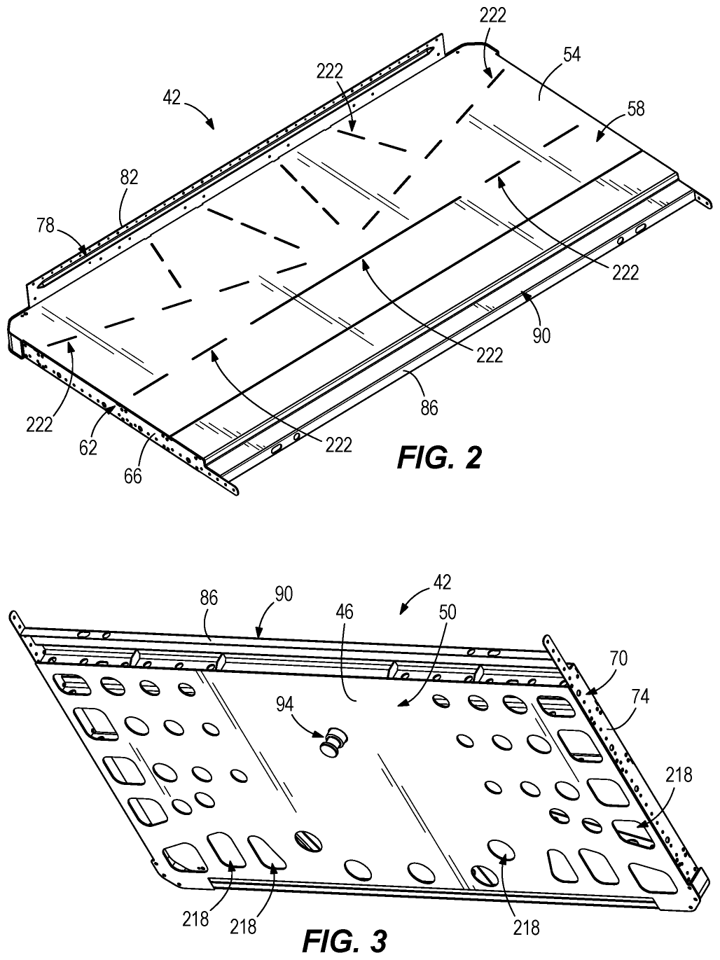

With reference to FIGS. 2-5, the coupler assembly 42 includes a base plate 46 defining a lower wall 50 and an upper plate 54 opposite the base plate 46 and defining an upper wall 58. The upper plate 54 and the base plate 46 are formed of steel, such as 8 Gauge steel. The upper wall 58 of the coupler 42 defines a portion of the cargo area 14 of the trailer 10. The coupler assembly 42 also includes a first lateral wall 62 that is defined by a first lateral plate 66, a second lateral wall 70 that is defined by a second lateral plate 74, and a front wall 78 that is defined by a front plate 82. The first lateral plate 66 is coupled to the upper plate 54 and the base plate 46. Similarly, the second lateral plate 74 is coupled to the upper plate 54 and the base plate 46. The front plate 82 is coupled to the upper plate 54, the base plate 46, the first lateral plate 66, and the second lateral plate 74. The coupler assembly 42 also includes a rear plate 86 defining a rear wall 90 of the coupler assembly 42. In the illustrated embodiment, the rear plate 86 defines the rear wall 90 and a rearward portion of the upper wall 58. A downwardly protruding king pin assembly 94 is disposed within an area defined by the walls 50, 58, 62, 70, 78, 90 of the coupler assembly 42. The king pin assembly 94 includes a base 98 supporting a king pin 102. The king pin 102 protrudes downwardly beyond the lower wall 50 of the coupler assembly 42 to be selectively coupled to the tractor and is positioned equally between the first lateral wall 62 and the second lateral wall 70.

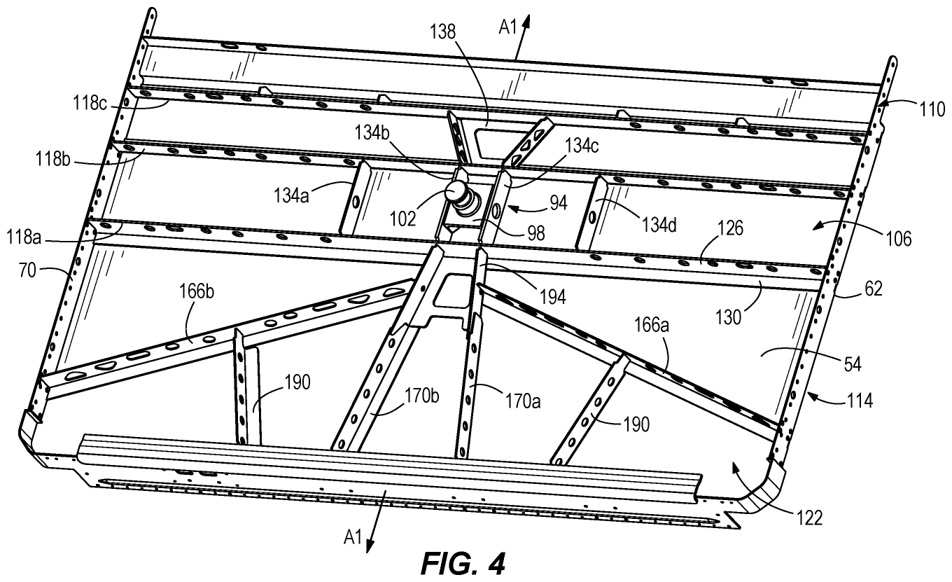

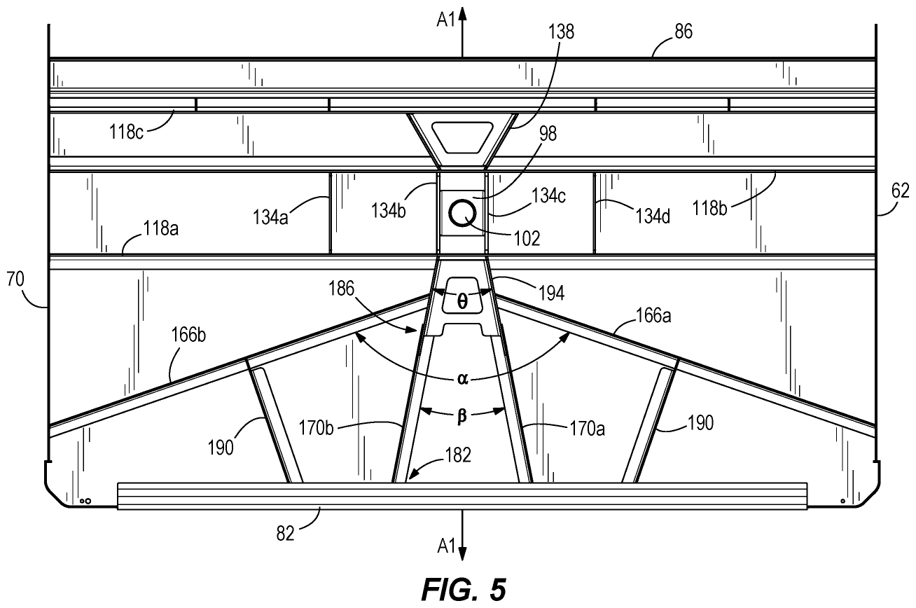

With continued reference to FIGS. 4-5, a support frame 106 is disposed within the coupler assembly 42 to distribute loads applied to the king pin assembly 94 when the trailer 10 is in use. The support frame 106 includes a rearward portion 110 in which the king pin assembly 94 is disposed and a forward portion 114 positioned between the king pin assembly 94 and the forward end 18 of the trailer 10. As will be described in greater detailer herein, the rearward portion 110 includes a plurality of rearward reinforcement members 118a, 118b, 118c positioned parallel to one another and orthogonally to the lateral walls 62, 70 to form a box-structure, and the forward portion 114 includes a plurality of forward reinforcement members 122 positioned at oblique angles to one another and to the walls 62, 70, 78, 90 of the coupler assembly 42. In some embodiments, the forward portion 114 includes a plurality of reinforcement members positioned parallel to one another and orthogonally to the lateral walls 62, 70, similarly to the rearward portion 110.

In the illustrated embodiment, the rearward portion 110 of the support frame 106 includes a first rearward reinforcement member 118a, a second rearward reinforcement member 118b, and a third rearward reinforcement member 118c. Each of the first, second, and third rearward reinforcement members 118a, 118b, 118c are spaced apart from one another along the longitudinal axis A1 of the trailer 10, and each of the rearward reinforcement members spans across a width of the coupler assembly 42 (e.g., transverse to the longitudinal axis A1). In other words, the rearward reinforcement members 118a, 118b, 118c extend from the first lateral wall 62 of the coupler assembly 42 to the second lateral wall 70 of the coupler assembly 42. The first rearward reinforcement member 118a is the forward-most reinforcement member of the plurality of rearward reinforcement members 118a, 118b, 118c. The third rearward reinforcement member 118c is the rearward-most reinforcement member of the plurality of rearward reinforcement members 118a, 118b, 118c. The second reinforcement member 118b is the located between the first reinforcement member 118a and the third reinforcement member 118c relative to the longitudinal axis A1. The king pin assembly 94 is positioned behind the first rearward reinforcement member 118a and in front of the second rearward reinforcement member 118b.

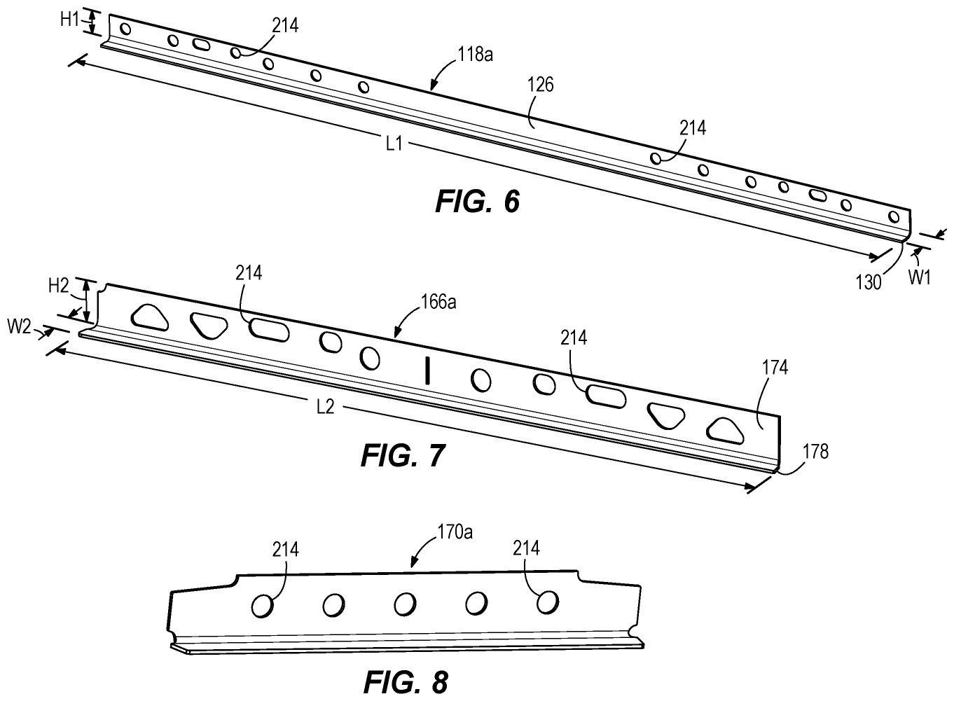

In the illustrated embodiment, each of the rearward reinforcement members 118a, 118b, 118c is substantially similar to the others. Accordingly, only the first rearward reinforcement member 118a will be described in detail herein, and it should be understood that the description of the first rearward reinforcement member 118a applies to the second and third rearward reinforcement members 118b, 118c as well. With reference to FIG. 6, the first rearward reinforcement member 118a includes a vertical wall 126 and a horizontal wall 130 extending transverse to the vertical wall 126. The vertical wall 126 defines a height H1 of the first rearward reinforcement member 118a, and the horizontal wall 130 defines a width W1 of the first rearward reinforcement member 118a. A length L1 of the first rearward reinforcement member 118a is measured perpendicular to the height H1 and width W1 directions of the first rearward reinforcement member 118a. The first rearward reinforcement member 118a is L-shaped in cross-section when taken perpendicular to the length L1. In the illustrated embodiment, the height H1 of the reinforcement member 118a is larger than the width W1 such that the “short” leg of the L-shape is the horizontal wall 130. The height H1 is sized such that the first rearward reinforcement member 118a is coupled to both the upper plate 54 and the base plate 46 of the coupler assembly 42. Referring now to FIG. 4, the horizontal wall 130 abuts against the upper plate 54, and the vertical wall 126 extends between the upper plate 54 and the base plate 46. In other embodiments, the horizontal wall 130 abut against the base plate 46 and the horizontal wall 130 may be larger than the vertical wall 126 (e.g., the width W1 is larger than the height H1).

With reference to FIGS. 4-5, the rearward portion 110 of the support frame 106 also includes four longitudinal braces 134a-d extending between and coupled to the first and second rearward reinforcement members 118a, 118b. The four longitudinal braces 134a-d are spaced laterally along the width of the coupler assembly 42. The central two braces 134b, 134c are coupled to the base 98 of the king pin assembly 94 to couple the king pin assembly 94 to the support frame 106. In the illustrated embodiment, the outboard longitudinal braces 134a, 134d are spaced apart from the central longitudinal braces 134b, 134c and are positioned within approximately a central ⅓ of the width of the coupler assembly 42. In other embodiments, the outboard longitudinal braces 134a, 134b may be spaced further from the longitudinal axis A1.

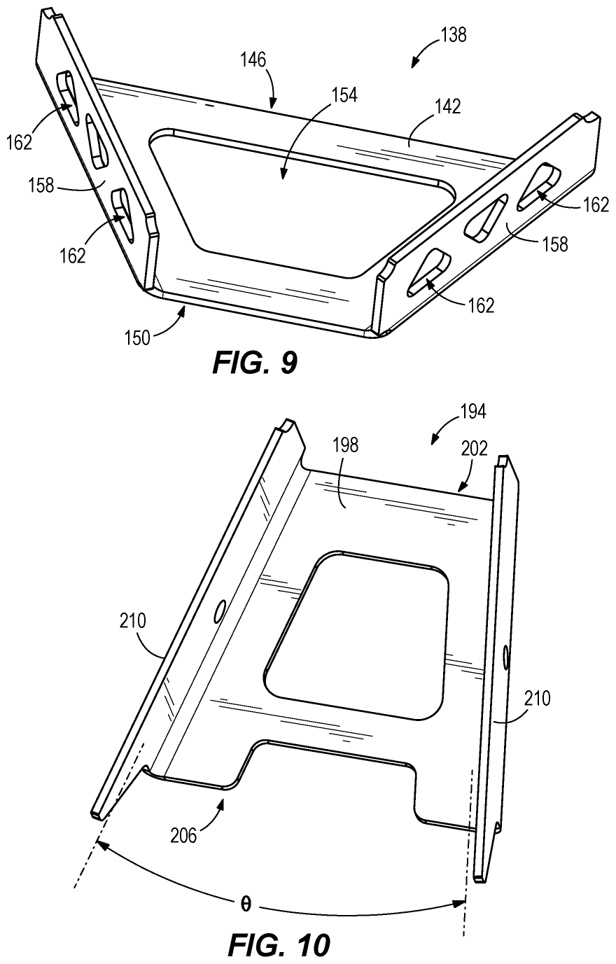

With continued reference to FIGS. 4, 5, and 9, a gusset 138 (e.g., a rearward gusset) is disposed between and coupled to the second and third rearward reinforcement members 118b, 118c. In the illustrated embodiment, the gusset 138 includes a base plate 142 in the shape of a truncated triangle having a foot 146 and a truncated tip 150. In other embodiments, the base plate 142 may be in the form of other shapes such as a rectangle or square. The foot 146 is wider than the truncated tip 150 and is coupled to the third rearward reinforcement member 118c. The truncated tip 150 is coupled to the second rearward reinforcement member 118b. The base plate 142 is coupled to the upper plate 54 of the coupler assembly 42 and includes an aperture 154. In the illustrated embodiment, the aperture 154 is a cutout that is generally triangular in shape to reduce the weight of the gusset 138. The gusset 138 further includes a pair of side walls 158 extending from the base plate 142. The pair of side walls 158 extend between the upper plate 54 and the base plate 46 of the coupler assembly 42. The pair of side walls 158 also extend between the second and third rearward reinforcement members 118b, 118c to couple the gusset 138 to the rearward portion 110 of the support frame 106. Each of the side walls 158 includes a plurality of holes 162 to decrease the weight of the gusset 138. In the illustrated embodiment, the holes 162 are triangular in shape. In other embodiments, the gusset 138 may have more or fewer apertures 154 or holes 162 depending on the desired weight and strength characteristics of the gusset 138.

While the rearward portion 110 of the support frame 106 has been described herein as including three laterally extending rearward reinforcement members 118, four longitudinal braces 134, and a gusset 138, it should be understood that other support frames may have more or fewer reinforcement members, braces, and gussets based on the size and intended strength of the coupler assembly.

With reference to FIGS. 4-5, the plurality of forward reinforcement members 122 of the forward portion 114 of the support frame 106 includes a pair of outboard reinforcement members 166a, 166b and a pair of inboard reinforcement members 170a, 170b disposed within the pair of outboard reinforcement members 166a, 166b. The pair of outboard reinforcement members 166a, 166b includes a first outboard reinforcement member 166a extending from the first lateral wall 62 adjacent the front end 18 toward the longitudinal axis A1 and toward the rear end 22. A second outboard reinforcement member 166b of the pair of outboard reinforcement members 166a, 166b extends from the second lateral wall 70 toward the longitudinal axis A1 and toward the rear of the coupler assembly 42 and the trailer rear end 22. In other words, the first and second outboard reinforcement members 166a, 166b diverge toward the front of the coupler assembly 42 and the trailer front end 18. The first and second outboard reinforcement members 166a, 166b do not intersect; however, the outboard reinforcement members 166a, 166b form an obtuse included angle α therebetween that is bisected by the longitudinal axis A1 of the trailer 10. The first and second outboard reinforcement members 166a, 166b are therefore symmetric about the longitudinal axis A1 of the trailer 10.

The first outboard reinforcement member 166a is described in greater detail below with reference to FIG. 7. Only the first outboard reinforcement is 166a described in detail herein. However, it should be understood that the second outboard reinforcement member 166b is similar to the first outboard reinforcement 166a and the description of the first outboard reinforcement 166a applies to the second outboard reinforcement member 166b. The first outboard reinforcement member 166a includes a vertical wall 174 and a horizontal wall 178 extending transverse to the vertical wall 178. The vertical wall 174 defines a height H2 of the first outboard reinforcement member 166a, and the horizontal wall 178 defines a width W2 of the first outboard reinforcement member 166a. A length L2 of the first outboard reinforcement member is measured perpendicular to the height H2 and width W2 directions of the first outboard reinforcement member 166a. The first outboard reinforcement member 166a is L-shaped in cross-section when taken perpendicular to the length L2. In the illustrated embodiment, the height H2 of the first outboard reinforcement member 166a is larger than the width W2 of the first outboard reinforcement 166a such that the shorter leg of the L-shape is the horizontal wall 178. The height H2 of the first outboard reinforcement member 166a is such that the first outboard reinforcement member 166a is coupled to both the upper plate 54 and the base plate 46 of the coupler assembly 42. Referring now to FIG. 4, the horizontal wall 178 of the first outboard reinforcement member 166a abuts against the upper plate 54 of the coupler assembly 42, and the vertical wall 174 extends between the upper plate 54 and the base plate 46 of the coupler assembly 42. In other embodiments, the horizontal wall 178 may abut against the base plate 46, and the horizontal wall 178 may be larger than the vertical wall 174 (e.g., the width W2 may be larger than the height H2) so long as the height H2 spans between the upper plate 54 and the base plate 46.

With reference to FIGS. 4-5, the pair of inboard reinforcement members 170a, 170b includes a first inboard reinforcement member 170a and a second inboard reinforcement member 170b. The first inboard reinforcement member 170a extends from the front plate 82 of the coupler assembly 42 toward the rear of the coupler assembly 42 and the trailer rear end 22 and is angled inwards toward the king pin assembly 94 (e.g., toward the longitudinal axis A1). In other words, a forward end 182 of the first inboard reinforcement member 170a is spaced from the longitudinal axis A1 along the front plate 82 toward the first lateral wall 62. A rearward end 186 of the first inboard reinforcement member 170a is positioned closer to the longitudinal axis A1 than the forward end 182. The second inboard reinforcement member 170b also extends from the front plate 82 of the coupler assembly 42 toward the rear end 22 and is angled inwards toward the king pin assembly 94 (e.g., toward the longitudinal axis A1). The second inboard reinforcement member 170b is positioned on an opposite side of the longitudinal axis A1 than the first inboard reinforcement member 170a, and the first and second inboard reinforcement members 170a, 170b are symmetric about the longitudinal axis A1. Therefore, the first and second inboard reinforcement members 170a, 170b diverge toward the front of the coupler assembly 42 and the trailer front end 18. The first and second inboard reinforcement 170a, 170b members do not intersect; however, the inboard reinforcement members 170a, 170b to form an acute included angle β therebetween that is bisected by the longitudinal axis A1 of the trailer 10. Furthermore, each of the inboard reinforcement members 170a, 170b forms an oblique angle with each of the outboard reinforcement members 166a, 166b. The inboard reinforcement members 170a, 170b are similar in shape to the outboard reinforcement members 166a, 166b (e.g., L-shaped in cross-section). Accordingly, it should be understood that the description of the geometry of the first outboard reinforcement member 166a applies equally to the inboard reinforcement members 170a, 170b.

With continued reference to FIGS. 4-5, the forward portion 114 of the support frame 106 includes a pair of braces 190 extending between the front plate 82 and the pair of outboard reinforcement members 166a, 166b. Each brace 190 is oriented transverse to the outboard reinforcement member 166a, 166b that it intersects and is coupled to the front plate 82 at an oblique angle. Furthermore, each brace 190 is similar in shape to the other reinforcement members and is L-shaped in cross-section.

With continued reference to FIGS. 4, 5, and 10, the forward portion 114 of the support frame 106 further includes a gusset 194 (e.g., a forward gusset 194) disposed forward of the king pin assembly 94. The gusset 194 couples the forward portion 114 of the support frame 106 to the rearward portion 110 and to the king pin assembly 94. The gusset 194 includes a trapezoidal base plate 198 having a head 202 positioned adjacent the king pin assembly 94 and a foot 206 opposite the head 202. The foot 206 is wider than the head 202 such that the wider portion of the gusset 194 is the forward-most portion of the gusset 194. In other embodiments, the gusset 194 may have a different shaped base plate 198. For example, the gusset 194 may utilize a rectangular or square shaped base plate. The gusset 194 also includes two side walls 210 extending from the base plate 198 and between the head 202 and the foot 206. The sidewalls 210 of the illustrated embodiment are oriented transverse to the base plate 198 and form an acute angle θ with one another. The angle θ between the sidewalls 210 is equal to the angle β between the inboard reinforcement members 170a, 170b. The gusset 194 is positioned centrally along the width of the coupler assembly 42 (e.g., is bisected by the longitudinal axis A1) and is a joining structure for the pair of outboard reinforcement members 166a, 166b and the pair of inboard reinforcement members 170a, 170b. More particularly, the inboard reinforcement members 170a, 170b are coupled to the gusset 194 and parallel with the sidewalls 210 of the gusset 194. The outboard reinforcement members 166a, 166b are coupled to the gusset 194 and intersect the sidewalls 210 of the gusset 194 at oblique angles.

While the forward portion 114 of the support frame 106 has been described herein as including a pair of outboard reinforcement members 166, a pair of inboard reinforcement members 170, and a pair of braces 190 that all intersect at oblique angles, it should be understood that the specific orientation (e.g., the specific angles and components to which they are coupled) of the forward portion 114 may change based on the size or desired strength of the coupler assembly 42. For example, in some embodiments the forward portion 114 of the support frame 106 may include a plurality of reinforcement members oriented parallel to one another. The plurality of reinforcement members may also be parallel to the longitudinal axis A1 and spaced such that the forward portion 114 of the support frame is symmetric about the longitudinal axis A1.

The support frame 106 includes a plurality of components, each of which may include a plurality of lightening holes 214. The lightening holes 214 are strategically located to remove material and thus weight from the support frame 106 while maintaining the strength of the support frame 106. Similarly, the base plate 46 of the coupler assembly 42 includes a plurality of lightening holes 218 to decrease the weight of the base plate 46 while maintaining adequate the strength of the coupler assembly 42. The lightening holes 214, 218 may be in any shape and location, based on the loads carried by the coupler assembly 42 so long as they do not sacrifice the strength of the coupler assembly 42.

In some constructions, the coupler assembly 42 is formed of steel and the components of the coupler assembly 42 are welded to one another. For example, the base plate 46 may be formed of 8 Gauge steel, the rearward portion 110 of the support frame 106 may be formed of 4 Gauge steel, and the forward portion 114 of the support frame may be formed of 8 Gauge steel. When assembled, the support frame 106 is welded to both the base plate 46 and the upper plate 50. The illustrated construction allows for the use of automated welding techniques to secure the components of the coupler assembly 42. For example, the support frame 106 may first be welded to the base plate 46 while the upper plate 54 is removed to provide access for the welding machine. The upper plate 54 may then be welded to the coupler assembly 42. The upper plate 54 includes a plurality of slots 222 that are aligned with the reinforcement members 118a, 118b, 118c, 166a, 166b, 170a, 170b of the support frame 106 when the upper plate 54 is in place in the coupler assembly 42. The plurality of slots 222 provide a clearance for the automated welding machine to apply a weld between the upper plate 54 and the respective reinforcement member from outside of the coupler assembly 42 (e.g., from above the upper plate 54). In the illustrated embodiment, each reinforcement member 118a, 118b, 118c, 166a, 166b, 170a, 170b is oriented such that the short leg of the L is welded to the upper plate 54 within the slot 222.

The embodiments described above and illustrated in the figures are presented by way of example only and are not intended as a limitation upon the concepts and principles of the present invention. As such, it will be appreciated by one having ordinary skill in the art that various changes in the elements and their configuration and arrangement are possible without departing from the spirit and scope of the present invention. For example, one having ordinary skill in the art will appreciate that specific features of the numerous embodiments disclosed may be mixed and matched in other ways where not specifically inhibited, even though specific illustration of such embodiments may not be exhaustively covered herein.

What is claimed is:

1. A coupler assembly for a trailer, the coupler assembly comprising:
a base plate;
a king pin assembly coupled to the base plate and including a king pin extending downwardly from the base plate, the king pin configured to be coupled to a fifth wheel of a tractor; and
a support frame coupled to the base plate and configured to brace the king pin assembly, the support frame including:
a pair of outboard reinforcement members forming an obtuse included angle therebetween, and
a pair of inboard reinforcement members forming an acute included angle therebetween, the pair of inboard reinforcement members disposed within the obtuse included angle formed by the pair of outboard reinforcement members,
wherein the obtuse included angle formed by the pair of outboard reinforcement members and the acute included angle formed by the pair of inboard reinforcement members are each bisected by a longitudinal axis of the coupler assembly.

2. The coupler assembly of claim 1, wherein each of the pair of outboard reinforcement members forms an oblique angle with each of the pair of inboard reinforcement members.

3. The coupler assembly of claim 1, further comprising a gusset coupled to the pair of outboard reinforcement members and to the pair of inboard reinforcement members, the gusset bisected by the longitudinal axis of the coupler assembly.

4. The coupler assembly of claim 3, wherein the gusset is coupled to the king pin assembly.

5. The coupler assembly of claim 1, wherein the support frame further comprises a pair of braces, each brace of the pair of braces extending between a front of the coupler assembly and one of the pair of outboard reinforcement members.

6. The coupler assembly of claim 5, wherein each brace is oriented perpendicularly to one of the pair of outboard reinforcement members.

7. The coupler assembly of claim 1, wherein each reinforcement member is L-shaped in cross-section taken perpendicular to a length thereof.

8. A coupler assembly for a trailer, the coupler assembly comprising:
a lower wall;
an upper wall disposed opposite the lower wall;
a first lateral wall extending in a longitudinal direction of the trailer, the first lateral wall coupled to the lower wall and to the upper wall;
a second lateral wall opposite the first lateral wall, the second lateral wall coupled to the lower wall and to the upper wall;
a front wall positioned at a forward end of the trailer, the front wall extending laterally between the first lateral wall and the second lateral wall, the front wall coupled to the lower wall and to the upper wall;
a king pin assembly disposed in an area defined within the first lateral wall, the second lateral wall, and the front wall and extending downwardly beyond the lower wall;
a plurality of forward reinforcement members disposed between the king pin assembly and the front wall; and
a plurality of rearward reinforcement members,
wherein the plurality of forward reinforcement members are disposed at oblique angles relative to the front wall, the first lateral wall, and the second lateral wall.

9. The coupler assembly of claim 8, wherein the plurality of rearward reinforcement members are oriented parallel to one another and are oriented orthogonally to the first lateral wall and to the second lateral wall to form a box-structure.

10. The coupler assembly of claim 8, wherein the plurality of forward reinforcement members includes a pair of outboard reinforcement members extending inwards from each of the first lateral wall and the second lateral wall, respectively, and wherein the pair of outboard reinforcement members define an obtuse included angle therebetween.

11. The coupler assembly of claim 10, wherein the plurality of forward reinforcement members includes a pair of inboard reinforcement members extending toward the king pin assembly from the front wall, the pair of inboard reinforcement members defining an acute included angle therebetween.

12. The coupler assembly of claim 11, wherein each of the plurality of forward reinforcement members is L-shaped in cross-section.

13. The coupler assembly of claim 11, wherein each of the plurality of forward reinforcement members includes a plurality of holes therein.

14. The coupler assembly of claim 8, further comprising a gusset configured to couple the king pin assembly to the plurality of forward reinforcement members.

15. The coupler assembly of claim 14, wherein the gusset is a forward gusset, further comprising a rearward gusset configured to couple the king pin assembly to the plurality of rearward reinforcement members.

16. A cargo trailer comprising:
a cargo area defined between a front end and a rear end, the rear end having an opening configured for loading and unloading cargo; and
a coupler assembly provided at a bottom portion of the front end, the coupler assembly including:
a plurality of rearward reinforcement members,
a downwardly protruding kingpin disposed within the plurality of rearward reinforcement members, and
a plurality of forward reinforcement members, each of the plurality of forward reinforcement members having a L-shaped cross-section taken perpendicular to a length thereof.

17. The cargo trailer of claim 16, wherein the plurality of forward reinforcement members includes a pair of outboard reinforcement members, and wherein the pair of outboard reinforcement members are disposed to form an oblique included angle.

18. The cargo trailer of claim 17, wherein the plurality of forward reinforcement members includes a pair of inboard reinforcement members disposed form an acute included angle.

19. The cargo trailer of claim 18, wherein the plurality of forward reinforcement members diverge towards the front end of the cargo trailer.

20. The cargo trailer of claim 18, wherein the plurality of rearward reinforcement members are each L-shaped in cross-section.
